(19) United States
(12) Patent Application Publication
(10) Pub. No.: US 2024/0356101 A1
(43) Pub. Date: Oct. 24, 2024

(54) Battery Module and Battery Pack Including the Same

(71) Applicant: LG Energy Solution, Ltd., Seoul (KR)

(72) Inventors: Min Seop Kim, Daejeon (KR); Junyeob Seong, Daejeon (KR); Jongpil Jeon, Daejeon (KR)

(73) Assignee: LG Energy Solution, Ltd., Seoul (KR)

(21) Appl. No.: 18/683,589

(22) PCT Filed: Dec. 7, 2022
(86) PCT No.: PCT/KR2022/019768

§ 371 Date: Feb. 14, 2024

(30) Foreign Application Priority Data
Jan. 19, 2022 (KR) 10-2022-0007953

(51) Int. Cl. H01M 10/653; H01M 50/105; H01M 50/186; H01M 50/211

(52) U.S. Cl. CPC H01M 10/653; H01M 50/105; H01M 50/186; H01M 50/211

(57) ABSTRACT

A battery module includes a battery cell stack including a plurality of battery cells; and a module frame housing the battery cell stack. Each of the battery cells includes an electrode assembly and a battery case openable at its front and rear surfaces of the battery case. Each battery case houses an electrode assembly, and a scaling portion is formed on each of the front and the rear surface of the battery case.

### CROSS-REFERENCE TO RELATED APPLICATIONS

The present application is a national phase entry under 35 U.S.C. § 371 of International Application No. PCT/KR2022/019768 filed on Dec. 7, 2022, which claims the benefit of Korean Patent Application No. 10-2022-0007953 filed on Jan. 19, 2022, the entire contents of which are incorporated herein by reference.

### TECHNICAL FIELD

The present disclosure relates to a battery module and a battery pack including the same, and more particularly, to a battery module with improved cooling performance, and a battery pack including the same.

### BACKGROUND

With the technology development and increased demand for mobile devices, demand for secondary batteries as energy sources has been rapidly increasing. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

In small mobile devices, one, or two, or three battery cells are used per device, while medium- or large-sized devices such as vehicles require high power and large capacity. Therefore, a medium- or large-sized battery module having a plurality of battery cells electrically connected to one another is used.

Since medium- or large-sized battery modules are preferably manufactured with as small a size and weight as possible, a prismatic battery, a pouch-type battery, or the like, which can be stacked with high integration and has a small weight relative to capacity, is mainly used as a battery cell of the medium- or large-sized battery modules. Such a battery module has a structure in which a plurality of cell assemblies including a plurality of unit battery cells are connected in series to obtain high output. Further, the battery cell includes positive and negative electrode current collectors, a separator, an active material, an electrolyte, and the like, and thus can be repeatedly charged and discharged through an electrochemical reaction between components.

In recent years, amid the growing need for large-capacity structures including the structures' utilization as an energy storage source, there is an increasing demand for battery packs having a multi-module structure formed by assembling a plurality of battery modules in which a plurality of secondary batteries are connected in series and/or in parallel.

Further, when a plurality of battery cells are connected in series or in parallel to configure a battery pack, it is common to configure a battery module composed of at least one battery cell first and then configure a battery pack by using at least one battery module and adding other components.

Generally, when a secondary battery is overheated, the performance of the secondary battery may deteriorate, and in a worst case, may be at risk of an explosion or ignition. A plurality of secondary batteries, that is, a battery module or a battery pack having battery cells, can accumulate the heat emitted from the plurality of battery cells in a narrow space, which may rapidly raise the temperature of the battery module. In other words, a battery module including a large number of battery cells, and a battery pack equipped with such a battery module can obtain high output, but it is not easy to remove heat generated from the battery cells during charging and discharging. When the heat dissipation of the battery cell is not properly performed, deterioration of the battery cells is accelerated, the lifespan is shortened, and the possibility of explosion or ignition increases.

If a medium- or large-sized battery module is included in a battery pack for a vehicle, the battery module may be frequently exposed to direct sunlight and may be placed under high-temperature conditions, for example, in summer or in a desert.

FIG. 1 is a perspective view of a conventional battery module. FIG. 2 is a cross-sectional view taken along the cutting line A-A′ in FIG. 1. FIG. 3 is an enlarged view of a section B of FIG. 2.

Referring to FIGS. 1 to 3, a conventional battery module 10 includes a battery cell stack 12 in which a plurality of battery cells 11 are stacked in one direction, a module frame 25 that houses the battery cell stack 12, and end plates 15 that cover the front and rear surfaces of the battery cell stack 12. The module frame 25 includes a lower frame 30 that covers a lower part and both side surfaces of the battery cell stack 12, and an upper plate 40 that covers an upper surface of the battery cell stack 12. Additionally, a thermally conductive resin layer 31 located between the lower portion of the battery cell stack 12 and the bottom portion of the module frame 25 may be formed.

Referring to FIG. 3, the battery cell 11 of the conventional battery module 10 can be configured by folding or not folding the sealing portion 11a. When the sealing portion 11a is disposed as shown in FIG. 3, it is difficult to utilize the space between the upper plate 40 and the battery cell stack 12 due to the sealing portion 11a. Due to the arrangement of the sealing portion 11a, not only it is difficult to achieve an effective cooling effect through the upper portion of the battery module 10, but also the cooling performance is deteriorated by an air layer formed adjacent to the sealing portion 11a, such as the space between the sealing portion 11a and the main body of the battery module 10.

Therefore, there is a need for a new structure for solving the heat generation problem of a battery cell, which has the capability of high capacity, high energy, rapid charging, and the like.

### SUMMARY OF THE INVENTION

### Technical Problem

It is an object of the present disclosure to provide a battery module with improved cooling performance, and a battery pack including the same.

The objects of the present disclosure are not limited to the aforementioned objects, and other objects which are not mentioned herein should be clearly understood by those skilled in the art from the following detailed description and the accompanying drawings.

### Technical Solution

According to one embodiment of the present disclosure, there is provided a battery module comprising: a battery cell stack including a plurality of battery cells; and a module frame that houses the battery cell stack, wherein the battery cell comprises an electrode assembly; and a battery case that is opened at its front and rear surfaces housing the electrode assembly, and wherein a sealing portion is formed on each of the front and the rear surface of the battery case.

The battery case may be a tubular case that is opened at its front and rear surfaces.

The battery module may further comprise a thermally conductive resin layer located between the upper portion of the battery cell stack and the module frame, wherein an upper portion of the battery cell stack that contacts the thermally conductive resin layer may have a flat shape.

The battery cell may be sealed by the two sealing portions.

The battery cells further comprise electrode leads formed protrusively from the battery cells, and the sealing portion may be formed to be adjacent to the electrode lead.

The battery module according to another embodiment of the present disclosure further comprises a sealing portion formed at one side portion of the battery cell, wherein the sealing portion formed on the one side may be formed to protrude from the battery case.

The sealing portion formed at the one side portion may be formed to protrude from the unopened one surface of the battery case.

One side portion of the battery cell may be an upper one side portion of the battery case.

The sealing portion formed at the one side portion may be formed at an edge of the one side portion.

The protrusively formed sealing portion may be bent and adhered from the edge of the one side portion toward the center of the one side portion.

The sealing portion formed at the one side portion may be formed at the center of the one side portion.

The protrusively formed sealing portion may be bent and adhered from the center of the one side portion toward the edge of the one side portion.

According to yet another embodiment of the present disclosure, there is provided a battery pack comprising the above-mentioned battery module.

### Advantageous Effects

A battery module according to embodiments of the present disclosure includes a battery cell in which a sealing portion is minimized, thereby capable of effectively cooling a battery cell having temperature rises in a high current and rapid charging environment. In addition, the internal temperature deviation of the battery module can be minimized, thereby improving the stability of the battery module.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a conventional battery module;

FIG. 2 is a cross-sectional view taken along the cutting line A-A′ in FIG. 1;

FIG. 3 is an enlarged view of a section B of FIG. 2;

FIG. 4 is an exploded perspective view of a battery module according to one embodiment of the present disclosure;

FIG. 5 is a cross-sectional view of the battery module of FIG. 4;

FIG. 6 is an enlarged view of section C of FIG. 5;

FIG. 7 is a perspective view of a battery cell included in a battery module according to one embodiment of the present disclosure;

FIG. 8 is a perspective view of a battery case included in the battery cell of FIG. 7;

FIG. 9 is a cross-sectional view taken along the cutting line D-D′ of FIG. 7;

FIG. 10 is a front view of a battery cell included in a battery module according to another embodiment of the present disclosure;

FIG. 11 is a front view of the battery cell of FIG. 10 and a sealing part formed in the battery cell of FIG. 10 together; and

FIG. 12 is a front view of another type of sealing portion formed in the battery cell of FIG. 10.

### DETAILED DESCRIPTION OF THE EMBODIMENTS

Hereinafter, various embodiments of the present disclosure will be described in detail with reference to the accompanying drawings so that those skilled in the art can easily ascertain them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when a directional limitation is referred to as “planar,” it means that a target portion is viewed from the upper side, and when a directional limitation is referred to as “cross-sectional”, it means that a target portion is viewed from the side of a cross section cut vertically.

The terms “first,” “second,” etc. are used to explain various components, but the components should not be limited by the terms. These terms are only used to distinguish one component from the other component.

The battery module according to the present disclosure will be described.

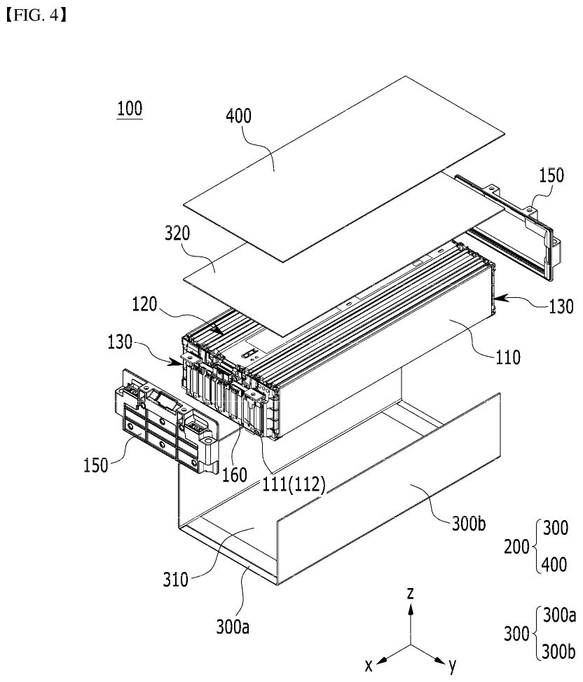

FIG. 4 is an exploded perspective view of a battery module according to one embodiment of the present disclosure.

Referring to FIG. 4, the battery module 100 according to the present embodiment includes a battery cell stack 120 in which a plurality of battery cells 110 are stacked, and a module frame 200 that houses the battery cell stack 120.

The module frame 200 includes a U-shaped frame 300 which is opened at its upper, front and rear surfaces and covers the lower portion and both side portions of the battery cell stack 120, and an upper plate 400 that covers the upper portion of the battery cell stack 120. At this time, the U-shaped frame 300 may include a bottom portion 300a supporting the lower portion of the battery cell stack 120, and side surface portions 300b each extending upward from both ends of the bottom portion 300a. The module frame 200 is not limited thereto, and can be replaced with a frame having another shape such as an L-shaped frame or a mono-frame surrounding the battery cell stack 120 except the front and rear surfaces. The battery cell stack 120 housed inside the module frame 200 can be physically protected through the module frame 200.

The upper plate 400 can cover the opened upper side surface of the module frame 200. The end plate 150 can cover the front and rear surfaces of the battery cell stack 120 that are opened in the module frame 200. The end plate 150 can be weld-coupled with the front and rear end edges of the upper plate 400 and the front and rear end edges of the module frame 200.

A busbar frame 130 can be formed between the end plate 150 and the front and rear surfaces of the battery cell stack 120. The busbar frame 130 can cover the portion of the battery cell stack 120 exposed from the module frame 200. The plurality of busbars 160 mounted to the busbar frame 130 are formed protrusively from the battery cells 110, and can be connected with the electrode leads 111 and 112 mounted on the busbar frame 130. A slot through which the electrode leads 111 and 112 pass may be formed in the busbar 160. Therefore, the electrode leads 111 and 112 and the busbar 160 passing through the slot of the busbar 160 may contact each other.

The battery module 100 according to the present embodiment further includes a first thermal conductive resin layer 310 located between the lower surface of the battery cell stack 120 and the bottom portion of the module frame 200, that is, the bottom portion 300a of the frame member 300, wherein the first thermal conductive resin layer 310 may facilitate transferring heat generated in the battery cell 110 to the bottom of the battery module 100 and fixing the battery cell stack 120.

Moreover, the battery module 100 according to the present embodiment may further include a second thermally conductive resin layer 320 formed between the upper portion of the battery cell stack 120 and the upper portion of the module frame 200, that is, the upper plate 400. Therefore, the heat generated in the battery cell 110 can be transferred even through the upper portion of the module frame 200 via the second thermally conductive resin layer 320.

In particular, the battery module 100 according to the present embodiment includes a heat transfer path to the upper portion of the module frame 200 through the second thermally conductive resin layer 320, rather than a one-way path through the bottom portion of the module frame 200, thereby improving the cooling performance. A first thermally conductive resin layer 310 and a second thermally conductive resin layer 320 may be formed by a method of applying and curing a thermal resin. The first thermally conductive resin layer 310 and the second thermally conductive resin layer 320 are illustrated in a plate shape, but in the process of applying and then curing the thermally conductive resin, it can be freely deformed in accordance with the shape of other components.

A conventional battery module according to the prior art is configured to release the heat generated in the battery cells through the thermal conductive resin layer formed at a lower portion of the battery cell. However, results in heat generated within the battery cells not being able to be efficiently cooled by the thermally conductive resin layer formed under the battery cell stack and through a cooling structure through the one-way path via the bottom portion of the module frame.

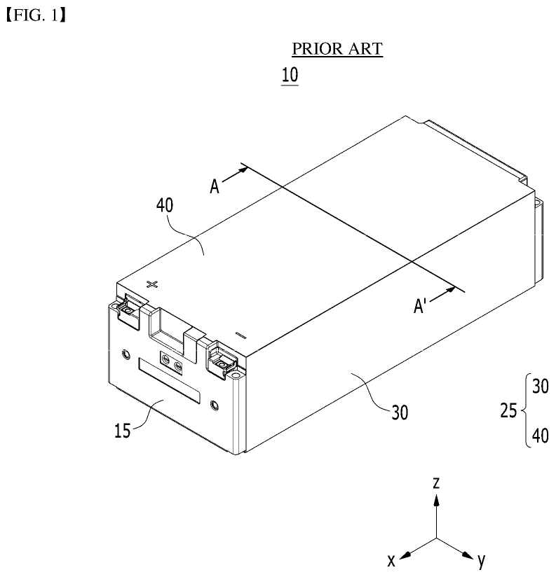

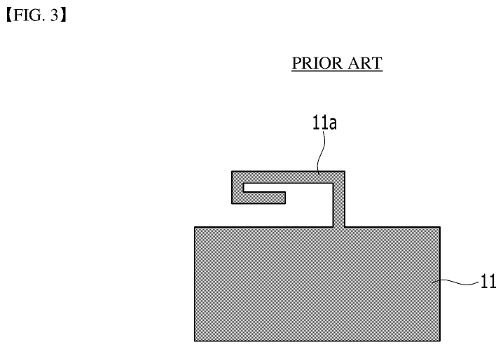

Referring to FIGS. 1 to 3, a battery cell 10 of a conventional battery module is inefficient in that when a sealing portion 11a is formed, and an air layer formed adjacent to the sealing portion 11a, such as a space between the sealing portion 11a and the body of the battery cell 10, the cooling performance is reduced. Moreover, when the space occupied by the sealing portion 11a is formed relatively wide, the space efficiency is minimized.

Therefore, there is a need for a structure that can effectively cool the heat in a situation where the battery cells generate a large amount of heat in a short period of time due to the flow of a high current, such as rapid charging.

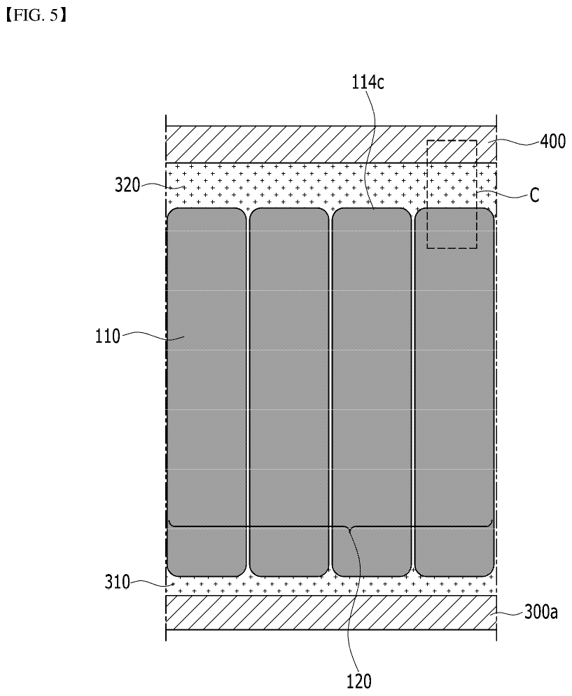

Next, the battery cell 110 included in the battery module 100 according to the present embodiment will be described in more detail with reference to FIGS. 5 to 9.

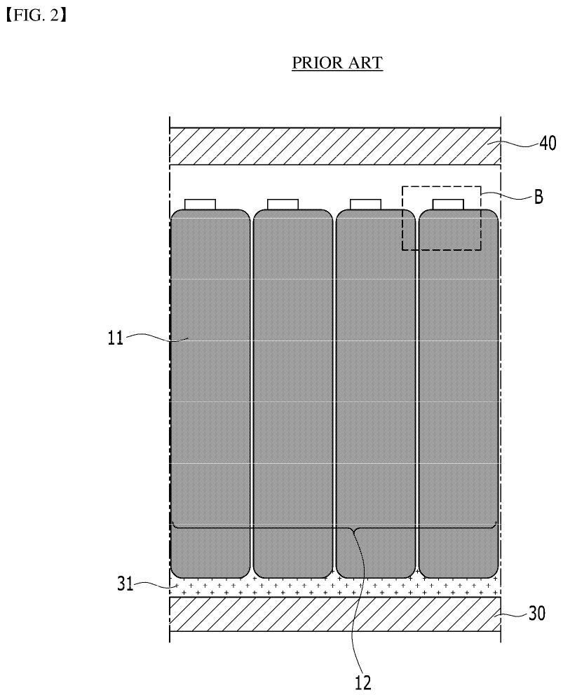

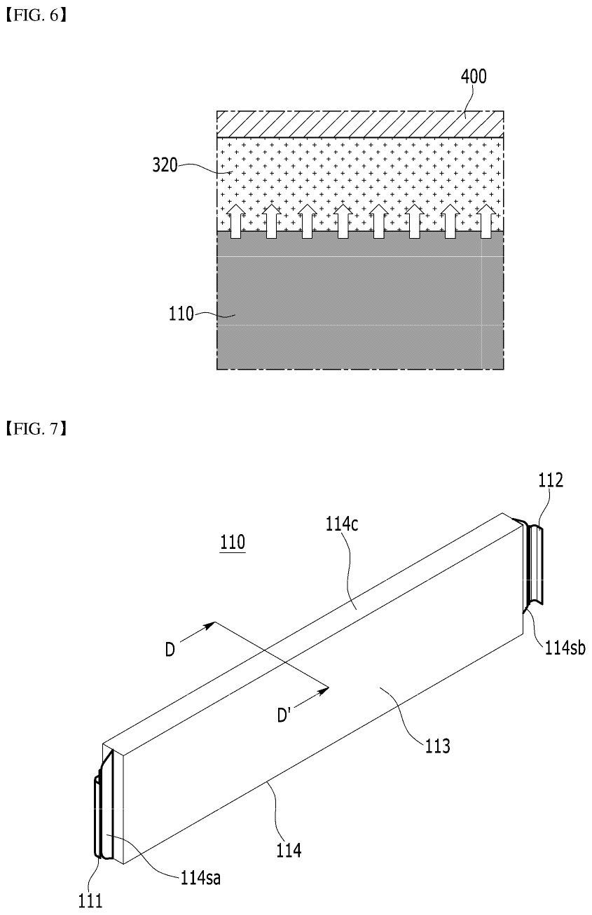

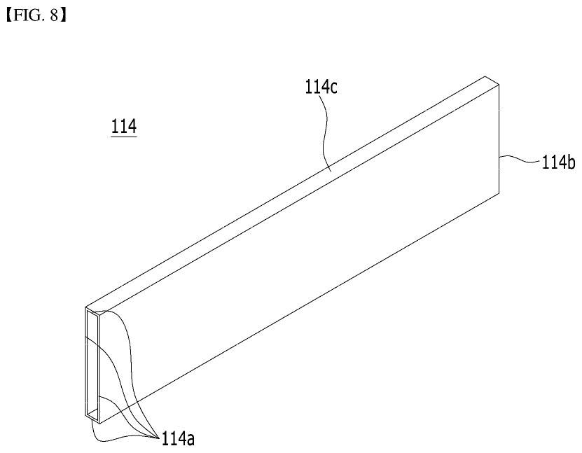

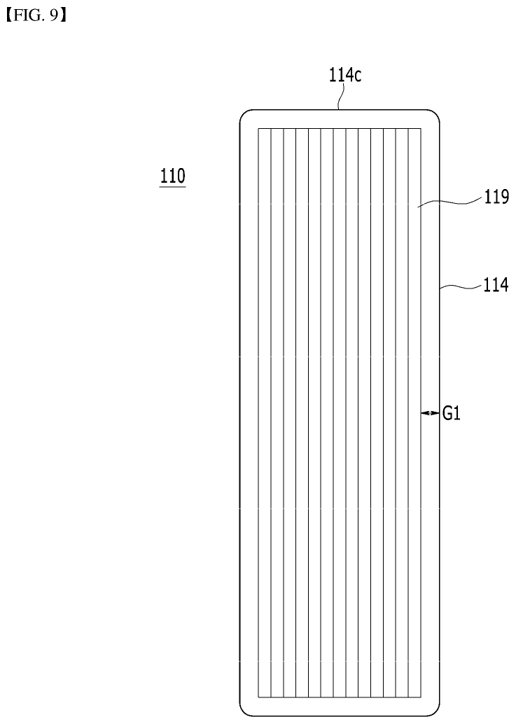

FIG. 5 is a cross-sectional view of the battery module according to one embodiment of the present disclosure taken along the cutting line A-A′ of FIG. 2. FIG. 6 is an enlarged view of a section C of FIG. 5. FIG. 7 is a perspective view showing a battery cell included in a battery module according to one embodiment of the present disclosure. FIG. 8 is a perspective view showing a battery case included in the battery cell of FIG. 7. FIG. 9 is a cross-sectional view taken along the cutting line D-D′ of FIG. 7.

Referring to FIGS. 4 to 9, the battery cell 110 included in the battery module 100 according to the present embodiment includes an electrode assembly 119 and a battery case 114 that is opened at its front and rear sides and houses the electrode assembly 119, wherein sealing portions 114sa and 114sb are formed on each of the front and rear surfaces of the battery case 114. The electrode assembly 119 may include a positive electrode, a negative electrode, and a separator disposed between the positive electrode and the negative electrode.

The battery cell 110 is preferably a pouch-type battery cell, and can be formed in a rectangular sheet-like structure. For example, referring to FIG. 7, the battery cell 110 according to the present embodiment has a structure in which two electrode leads 111 and 112 face each other and protrude from one end 114a and the other end 114b of the cell main body 113, respectively. That is, the battery cell 110 includes electrode leads 111 and 112 that protrude in mutually opposite directions. More specifically, the electrode leads 111 and 112 are connected to an electrode assembly 119, and protrude from the electrode assembly 119 to the outside of the battery cell 110.

The battery cell 110 may include a battery case 114, wherein the battery case 114 may be opened at its front and rear surfaces. Referring to FIG. 8, the battery case 114 may be a tubular case that is opened at its front and rear surfaces. Therefore, the electrode assembly 119 may be housed inside the battery case 114 through the front or rear surface of the battery case 114. The battery case 114 may be made of a laminate sheet including a resin layer and a metal layer.

The battery case 114 may have ends 114a and 114b and one side portion 114c connecting both ends 114a and 114b. The one side portion 114c may be formed in both the upper and lower portions of the battery case 114 of FIG. 8, but the one side portion 114c may represent the upper one side part 114c formed thereon. More specifically, the one side portion 114c may represent an upper surface of the battery case 114. In addition, both ends 114a and 114b of the battery case 114 can be formed in an opened shape, thus forming opened front and rear surfaces of the tubular case.

The battery cell 110 can be produced by joining both ends 114a and 114b of a cell case 114 when an electrode assembly 119 is housed in a cell case 114.

The battery cell 110 according to the present embodiment has a total of two sealing portions by adhering both ends 114a and 114b of the battery case 114, and the sealing portions 114sa and 114sb may have a structure that is sealed by a method such as heat sealing. Therefore, the battery cell 110 can be sealed by two sealing portions 114sa and 114sb.

The front sealing portion 114sa and the rear sealing portion 114sb may be respectively formed to be adjacent to the electrode leads 111 and 112. After the electrode leads 111 and 112 are formed to protrude from the battery cell 110, the sealing portions 114sa and 114sb are formed to complete the sealing structure of the battery cell 110.

Such a battery cell 110 may be formed in a plurality of battery cells 110, and the plurality of battery cells 110 may be stacked to be electrically connected to each other, thereby forming a battery cell stack 120. Particularly, as shown in FIG. 4, a plurality of battery cells 110 may be stacked along the direction parallel to the y-axis. Accordingly, the electrode leads 111 and 112 may protrude in the x-axis direction and the-x-axis direction, respectively.

When the battery cells 110 are repeatedly charged and discharged, since a lot of heat may be generated, a novel structure for cooling the battery cell 110 may be required.

Conventional battery modules reduce cooling efficiency due to the space occupied by the sealing portion of the battery cell, particularly when applying the thermally conductive resin layer to the upper portion.

Referring to FIGS. 5 and 6, the battery cell 110 according to the present embodiment further comprises a second thermally conductive resin layer 320 located between the upper portion of the module frame 200 and the battery cell stack 120, and an upper portion of the battery cell stack 120 that contacts the second thermally conductive resin layer 320 may have a flat shape.

Referring to FIG. 6, the upper portion of the battery cell stack 120 may have a flat shape, wherein the flat shape may correspond to one side portion 114c of the battery cell 110. That is, one side portion 114c of the battery cell 110 is an integral portion of the tubular case, and is not formed with a sealing portion, and thus may be formed in a flat shape.

The battery cell 110 of the battery module 100 according to the present embodiment is configured such that the sealing portions 114sa and 114sb are formed only on the front and rear surfaces of the battery case 114, except the one side portion 114c, thereby capable of minimizing a space occupied by the sealing portion. In particular, since the space occupied by the sealing portion is minimized, the heat transfer resistance can be minimized and the cooling performance of the battery module can be improved.

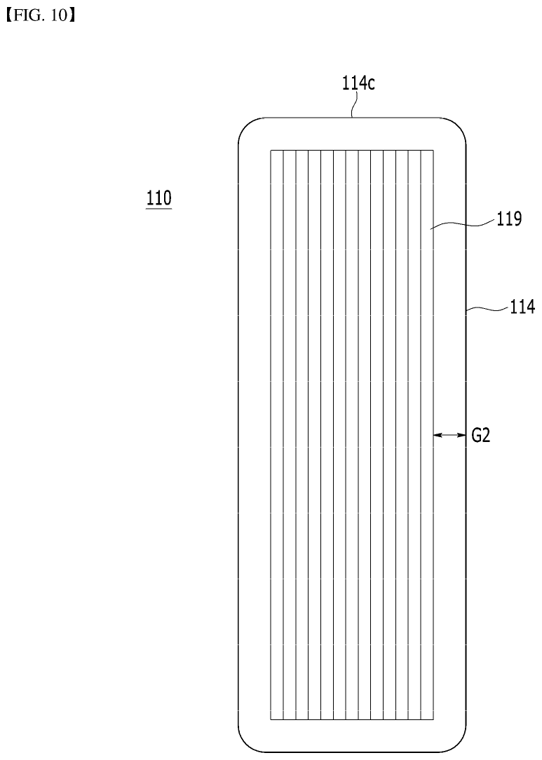

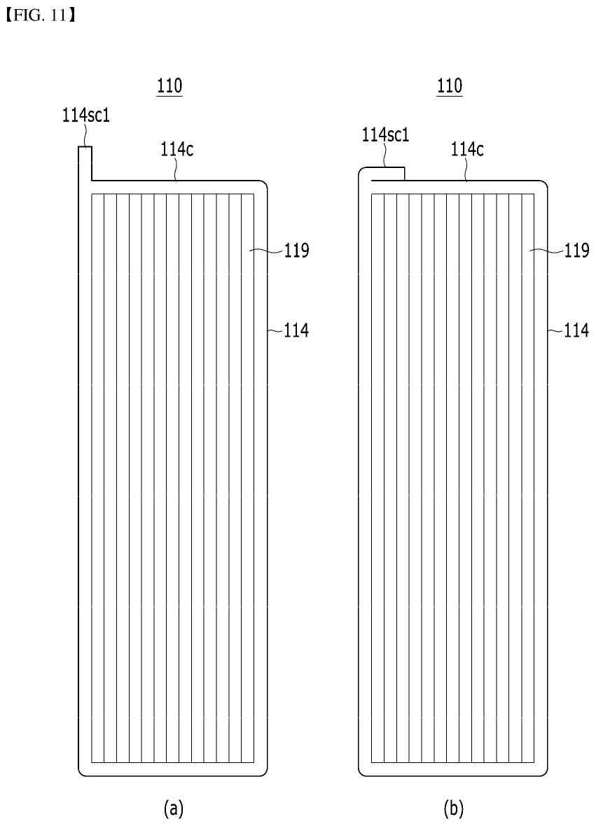

A battery cell included in a battery module according to another embodiment of the present disclosure will be described with reference to FIGS. 10 to 12. Since the details of the battery module and battery cell overlap with the contents described above, only the contents different therefrom will be described for brevity.

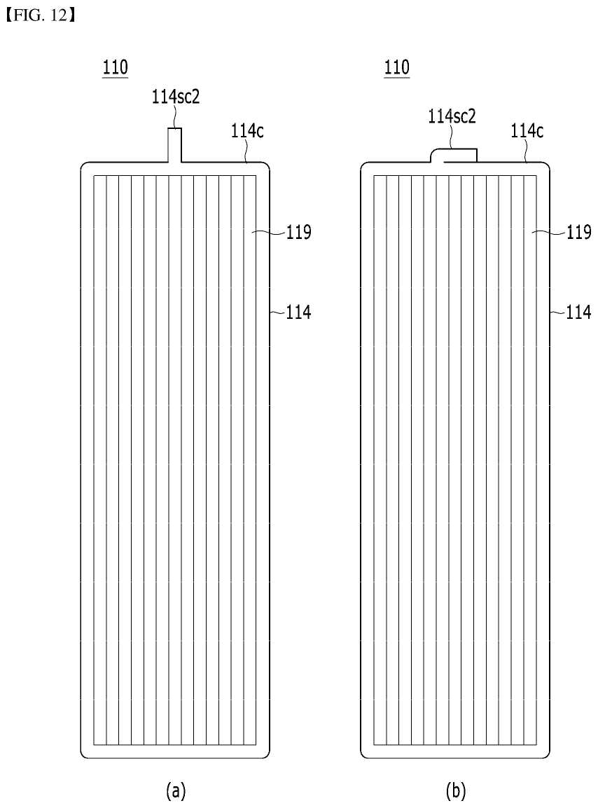

FIG. 10 is a diagram showing a battery cell included in a battery module according to another embodiment of the present disclosure. FIG. 11 is a diagram showing the battery cell of FIG. 10 and a sealing part formed in the battery cell of FIG. 10 together. FIG. 12 is a view showing together another type of sealing portion formed in the battery cell of FIG. 10.

Referring to FIGS. 9 and 10, the battery cell 110 may be configured to form spaces G1 and G2 between the battery case 114 and the electrode assembly 119. Referring to FIGS. 9 and 10 together, in the battery cell 110 described above, a space G1 can be formed between the battery case 114 and the electrode assembly 119, but in the battery cell 110 according to the present embodiment, the space G2 between the battery case 114 and the electrode assembly 119 may be widened by a margin size in consideration of the insertion of the electrode assembly 119. Therefore, in the battery cell 110 according to the present embodiment, a space G2 is formed between the battery case 114 and the electrode assembly 119 including the margin size in consideration of the insertion of the electrode assembly 119, whereby the efficiency can be increased, and the electrode assembly 119 can be easily inserted into the battery case 114.

After the electrode assembly 119 is inserted, the space G2 between the battery case 114 and the electrode assembly 119 is minimized to prevent the electrode assembly 119 from moving inside the battery cell 110 and, at the same time, sealing portions 114sc1 and 114sc2 can be formed at one side portion 114c of the battery case 114 in order to maximize the cooling surface.

The sealing portions 114sc1 and 114sc2 may be formed by compressing one side portion 114c of the battery case 114, and they may be formed by a heat-sealing method, similar to the front sealing portion 114sa and the rear sealing portion 114sb.

The sealing portions 114sc1 and 114sc2 formed at one side portion 114c may be formed by protruding a part of the tubular case. That is, it may be a structure in which portions corresponding to the already closed areas are further protruded and crimped to protrude from the unopened one surface of the battery case, instead of adhering and sealing portions corresponding to the opened areas, similar to the front sealing portion 114sa and the rear sealing portion 114sb. Therefore, a part of the already closed battery case 114 is formed as the sealing portions 114sc1 and 114sc2, so that the sealing portions 114sc1 and 114sc2 formed at one side portion 114c can be used as a gas storage space of the battery cell 110.

Referring to FIG. 11, the sealing portion 114sc1 formed at one side portion 114c may be formed at an edge of the one side portion 114c. At this time, the sealing portion 114sc1 formed at the edge of the one side portion 114c may be formed protrusively from the one side portion 114c. The protruding sealing portion 114sc1 may be formed to be bent and adhered from the edge of the one side portion 114c toward the center of the one side portion 114c. Therefore, even if the space G2 between the battery case 114 and the electrode assembly 119 is formed to include the margin size, not only can the electrode assembly 119 be fixed after the electrode assembly 119 is inserted, but also the cooling performance can be maintained and improved by minimizing the space occupied by the formation of the sealing portion 114sc1.

Further, referring to FIG. 12, the sealing portion 114sc2 formed at one side portion 114c may be formed at the center of the one side portion 114c. The sealing portion 114sc2 formed at the center of the one side portion 114c may be formed to protrude from the one side portion 114c. The protruding sealing portion 114sc2 may be formed to be bent and adhered from the center of the one side portion 114c toward the edge of the one side portion 114c. Therefore, the space occupied by the formation of the sealing portion 114sc1 can be minimized, thereby maintaining and improving the cooling performance.

In the battery cell 110 included in the battery module 100 of the present disclosure, the battery case 114 is formed into a tubular case. Thus, even if sealing portions are formed only on the front and rear surfaces, and the sealing portion is formed at one side portion 114c, the space occupied by the sealing portion can be minimized, thereby maximizing the cooling effect of the battery cell.

Next, a battery pack according to yet another embodiment of the present disclosure will be described.

A battery pack according to the present embodiment comprises the above-mentioned battery module. In addition, the battery pack of the present disclosure may have a structure in which one or more of the battery modules according to the present embodiment are gathered, and packed together with a battery management system (BMS) and a cooling device that control and manage battery's temperature, voltage, etc.

The battery pack can be applied to various devices. Such a device can be applied to a vehicle means such as an electric bicycle, an electric vehicle, or a hybrid vehicle, but the present disclosure is not limited thereto, and is applicable to various devices that can use a battery module, which also falls under the scope of the present disclosure.

Although preferred embodiments of the present disclosure have been illustrated and described above, the scope of the present disclosure is not limited to specific embodiments described above, and numerous other modifications can be carried out by those skilled in the art, without departing from the spirit and scope of the principles of the invention described in the appended claims. Further, these modifications should not be understood individually from the technical spirit or perspective of the present disclosure.

### DESCRIPTION OF SELECT REFERENCE NUMERALS

100: battery module
110: battery cell
114sa, 114sb: front and rear sealing portions
114sc1, 114sc2: sealing portion formed at one side portion
120: battery cell stack
130: busbar frame
150: end plate
160: busbar
200: module frame
300: U-shaped frame
400: upper plate

1. A battery module comprising:
a battery cell stack including a plurality of battery cells; and
a module frame housing the battery cell stack,
wherein each of the plurality of battery cells includes
an electrode assembly and
a battery case openable at front and rear surfaces of the battery case, the battery case housing the electrode assembly, and
wherein a sealing portion is formed on each of the front and the rear surface of the battery case.

2. The battery module according to claim 1, wherein:
each of the battery cases is a tubular case openable at its front and rear surfaces.

3. The battery module according to claim 1,
further comprising a thermally conductive resin layer located between an upper portion of the battery cell stack and the module frame,
wherein an upper portion of the battery cell stack contacting the thermally conductive resin layer is flat.

4. The battery module according to claim 1, wherein:
each of the plurality of battery cells is sealed by the sealing portions on the front and rear surfaces of the respective battery case.

5. The battery module according to claim 1, wherein:
each of the plurality of battery cells further comprise electrode leads protruding from the respective battery cell, and
the sealing portion is positioned adjacent to the electrode lead.

6. The battery module according to claim 1,
further comprising a sealing portion formed at one side portion of each of the plurality of battery cells,
wherein the sealing portion formed at the one side portion of each of the plurality of battery cells protrudes from the respective battery case.

7. The battery module according to claim 6, wherein:
the sealing portion formed at the one side portion of each of the plurality of battery cells protrudes from an unopened surface of the respective battery case, the unopened surface being one of the front and rear surfaces of the respective battery case.

8. The battery module according to claim 6, wherein:
the one side portion of each of the plurality of battery cells is an upper one side portion of the respective battery case.

9. The battery module according to claim 6, wherein:
the sealing portion formed at the one side portion of each of the plurality of battery cells is formed at an edge of the respective one side portion.

10. The battery module according to claim 9, wherein:
each of the protruding sealing portions is bent and adhered from the edge of the respective one side portion toward a center of the respective one side portion.

11. The battery module according to claim 6, wherein:
the sealing portion formed at the one side portion of each of the plurality of battery cells is formed at a center of the respective one side portion.

12. The battery module according to claim 11, wherein:
each of the protruding sealing portions is bent and adhered from the center of the respective one side portion toward the edge of the respective one side portion.

13. A battery pack comprising-the battery module of claim 1.
